(19) United States
(12) Patent Application Publication
(10) Pub. No.: US 2011/0171473 A1
(43) Pub. Date: Jul. 14, 2011

(54) MULTI-LAYERED LIGNOCELLULOSIC MOLDED BODIES WITH LOW FORMALDEHYDE EMISSIONS

(75) Inventors: Daniel Käsmayr, Ludwigshafen (DE); Stephan Weinkötz, Neustadt (DE); Christian Beil, Worms (DE); Michael Schmidt, Speyer (DE); Michael Finkenauer, Westhofen (DE)

(73) Assignee: BASF SE, Ludwigshafen (DE)

(21) Appl. No.: 13/119,882

(22) PCT Filed: Sep. 9, 2009
(86) PCT No.: PCT/EP2009/061690

§ 371 Date: Mar. 18, 2011

(30) Foreign Application Priority Data
Sep. 19, 2008 (EP) 08164736.4

(51) Int. Cl. B32B 27/18; B32B 37/02; B32B 37/10; B32B 27/42; B32B 27/40

(52) U.S. Cl. 428/413; 156/60; 428/424.2; 428/503

(57) ABSTRACT

A multilayer lignocellulose-containing molding comprising
A) a middle layer or a plurality of middle layers comprising lignocellulose-containing particles which is/are obtainable by using a binder (a) and
B) a covering layer or a plurality of covering layers comprising lignocellulose-containing particles which is/are obtainable by using a binder (b),
   the binder (a) being selected from the group consisting of (a1) formaldehyde resins and (a2) an organic isocyanate having at least two isocyanate groups;
   the binder (b) comprising the following components: an aqueous component (I) comprising
      (i) a polymer A which is composed of the following monomers:
      a) from 70 to 100% by weight of at least one ethylenically unsaturated mono- and/or dicarboxylic acid (monomer(s) A1) and
      b) from 0 to 30% by weight of at least one further ethylenically unsaturated monomer which differs from the monomers A1 (monomer(s) A2)
   and, optionally,
      (ii) a low molecular weight crosslinker having at least two functional groups which are selected from the group consisting of hydroxyl, carboxyl and derivatives thereof, primary, secondary and tertiary amine, epoxy, aldehyde
   and, optionally, a component (II), as an aqueous dispersion, comprising
   one or more polymer(s) M which is composed of the following monomers:
      a) from 0 to 50% by weight of at least one ethylenically unsaturated monomer which comprises at least one epoxide and/or at least one hydroxyalkyl group (monomer(s) M1) and
      b) from 50 to 100% by weight of at least one further ethylenically unsaturated monomer which differs from the monomers M1 (monomer(s) M2)
   and, optionally, customary additives as component (III),
   and, where the binder (a) comprises a formaldehyde resin, the binder (b) comprising formaldehyde scavengers.

The present invention relates to a multilayer lignocellulose-containing molding as defined in the claims.

Furthermore, the present invention relates to a process for the production of a multilayer lignocellulose-containing molding and the use of a multilayer lignocellulose-containing molding for the production of articles of all types and in the construction sector and for the production of pieces of furniture and furniture parts, of packaging materials, in house building or in interior finishing or in motor vehicles.

Materials based on lignocellulose are known. Important examples of lignocellulose-containing materials are wood parts, such as wood layers, wood strips, wood chips or wood fibers, it being possible for the wood fibers, optionally, also to originate from wood fiber-containing plants, such as flax, hemp, sunflowers, Jerusalem artichoke or rape. Starting materials for such wood parts or wood particles are usually timbers from the thinning of forests, residual industrial timbers and used timbers and wood fiber-containing plants.

The processing to give the desired lignocellulose-containing materials, such as wood particles, is effected by known processes, cf. for example M. Dunky, P. Niemt, Holzwerkstoffe and Leime, pages 91-156, Springer Verlag Heidelberg, 2002.

Lignocellulose-containing moldings, also referred to as wood-base materials here in the case of wood as lignocellulose, are an economical and resource-protecting alternative to solid wood and have become very important, particularly in furniture construction and as building materials. As a rule, wood layers of different thickness, wood strips, wood chips or wood fibers of various timbers serve as starting materials for wood-base materials. Such wood parts or wood particles are usually pressed at elevated temperature with natural and/or synthetic binders and, if appropriate, with addition of further additives to give board-like or strand-like wood-base materials. Examples of such lignocellulose-containing moldings or wood-base materials are medium density fiber boards (MDF), wood particle materials, such as particle boards and oriented strand boards (OSB), plywood, such as veneered plywood, and glued wood.

Binders used are as a rule formaldehyde-containing binders, for example urea-formaldehyde resins or melamine-containing urea-formaldehyde resins. The resins are prepared by polycondensation of formaldehyde with urea and/or melamine. The use of such formaldehyde resins can lead to the presence of free formaldehyde in the finished wood-base material. By hydrolysis of the polycondensates, additional formaldehyde may be liberated. The free formaldehyde present in the wood-base material and the formaldehyde liberated by hydrolysis during the life of the wood-base material can be released to the environment.

Above certain limits, formaldehyde can cause allergies and irritation of the skin, respiratory tract and eyes in humans. The reduction of the formaldehyde emission in components, especially in the interior sector, is therefore an important challenge.

The prior art discloses the following measures for reducing or suppressing the formaldehyde emission from wood-base materials:

The use of aminoplast glues which were prepared with little formaldehyde, the aftertreatment of the finished wood-base materials with so-called formaldehyde scavengers, such as compounds comprising amine groups, and the application of a covering layer to the wood-base material, the covering layer being obtained using a glue to which larger amounts of melamine and/or urea were added as formaldehyde scavengers.

However, such measures are still not completely satisfactory. The preparation of the aminoplast glues with little formaldehyde or the addition of formaldehyde scavengers to the aminoplast glue leads to the glue curing more slowly, which increases the residence times in the hot press and thus adversely affects the cost-efficiency of the production of the wood-base material.

DE-A 2 306771 (Deutsche Novopan GmbH) describes a process for the production of particle boards from, for example, woodchips to which binder has been added and which are sprinkled to give at least three layers and then hot-pressed, a certain phenol resin being used as a binder for the covering layer and, for example, isocyanate being used as a binder in the middle layer.

DE-A 2 306771 does not disclose binders of type (b) of the present invention.

DE 28 32 509 B1 (Deutsche Novopan GmbH) describes particle boards having a middle layer which was produced with urea-formaldehyde resin, isocyanate and addition of urea and a covering layer which was produced with urea-formaldehyde resin and added urea.

DE 28 32 509 B1 does not disclose binders of type (b) of the present invention.

EP 0 012 169 A1 (Fraunhofer-Gesellschaft) describes three-layer particle boards whose covering layer was glued with urea-formaldehyde resin and whose middle layer was produced using diisocyanates with or without addition of urea.

EP 0 012 169 A1 does not disclose binders of type (b) of the present invention.

The multilayer moldings described in the prior art still leave room for improvements with respect to mechanical strengths (for example peeling strength of the layers according to test standard EN 311) and reduction of the formaldehyde emissions.

The object of the present invention is accordingly to overcome the disadvantages described in the prior art. In particular, it was intended to provide multilayer lignocellulose-containing moldings whose formaldehyde emission was to be reduced or virtually absent, and the multilayer lignocellulose-containing moldings being intended to have good mechanical properties.

The object was achieved by a multilayer lignocellulose-containing molding comprising
A) a middle layer or a plurality of middle layers comprising lignocellulose-containing particles which is/are obtainable by using a binder (a) and
B) a covering layer or a plurality of covering layers containing lignocellulose-containing particles which is/are obtainable by using a binder (b),

the binder (a) being selected from the group consisting of (a1) formaldehyde resins and (a2) an organic isocyanate having at least two isocyanate groups;

the binder (b) comprising the following components:

an aqueous component (I) comprising
(i) a polymer A which is composed of the following monomers:
a) from 80 to 100% by weight of at least one ethylenically unsaturated mono- and/or dicarboxylic acid (monomer(s) A1) and
b) from 0 to 20% of at least one further ethylenically unsaturated monomer which differs from the monomers A1 (monomer(s) A2)
   and, optionally,
(ii) a low molecular weight crosslinker having at least two functional groups which are selected from the group consisting of hydroxyl, carboxyl and derivatives thereof, primary, secondary and tertiary amine, epoxy, aldehyde

and, optionally, a component (II), as an aqueous dispersion, comprising one or more polymer(s) M which is composed of the following monomers:
a) from 0 to 50% by weight of at least one ethylenically unsaturated monomer which comprises at least one epoxide and/or at least one hydroxyalkyl group (monomer(s) M1) and
b) from 50 to 100% by weight of at least one further ethylenically unsaturated monomer which differs from the monomers M1 (monomer(s) M2)

and, optionally, customary additives as component (III),

and, where the binder (a) comprises a formaldehyde resin, the binder (b) comprising formaldehyde scavengers.

The term lignocellulose is known to the person skilled in the art. Important examples of lignocellulose-containing particles are wood parts, such as wood layers, wood strips, wood chips or wood fibers, it being possible for the wood fibers to originate, optionally, also from wood fiber-containing plants, such as flax, hemp, sunflowers, Jerusalem artichoke or rape.

Wood particles, in particular wood fibers or wood chips, are preferred as lignocellulose-containing particles.

The binder (a) comprises a formaldehyde resin, preferably aminoplast resin (a1) and/or an organic isocyanate having at least two isocyanate groups (a2).

If the binder (a) comprises an aminoplast resin, the binder (a) as a rule also comprises the substances known to the person skilled in the art, generally used for aminoplasts and usually designated as curing agents, such as ammonium-sulfate or ammonium-nitrate or inorganic or organic acids, for example sulfuric acid, formic acid, or acid-generating substances, such as aluminum chloride, aluminum sulfate, in each case in the customary, small amounts, for example in the range from 0.1% by weight to 6% by weight, based on the total amount of aminoplast resin in the binder (a).

A formaldehyde resin is understood here as meaning polycondensates of compounds having at least one carbamido group (the carbamido group also called a carboxamido group) optionally partly substituted by organic radicals and an aldehyde, preferably form aldehyde; these resins are also called aminoplast resins. Formaldehyde resins are furthermore understood herein as meaning phenol-formaldehyde resins.

All formaldehyde resins known to the person skilled in the art, preferably those known for the production of wood-base materials, can be used as suitable formaldehyde resin. Such resins and their preparation are described, for example, in Ullmanns Enzyklopädie der technischen Chemie, 4th, revised and extended edition, Verlag Chemie, 1973, pages 403 to 424 “Aminoplaste” and Ullmann's Encyclopedia of Industrial Chemistry, vol. A2, VCH Verlagsgesellschaft, 1985, pages 115 to 141 “Amino Resins” and in M. Dunky, P. Niemz, Holzwerkstoffe and Leime, Springer 2002, pages 251 to 259 (UF resins) and pages 303 to 313 (MUF and UF with small amount of melamine).

Preferred formaldehyde resins are polycondensates of compounds having at least one carbamido group, including those partly substituted by organic radicals, and formaldehyde.

Particularly preferred formaldehyde resins are urea-formaldehyde resins (UF resins), melamine-formaldehyde resins (MF resins) or melamine-containing urea-formaldehyde resins (MUF resins) and phenol-formaldehyde resins (PF resins) and melamine-urea-phenol-formaldehyde resins (MUPF resins).

Very particularly preferred formaldehyde resins are urea-formaldehyde resins (UF resins) and melamine-formaldehyde resins (MF resins), for example Kaurit® or Kauramin® glue types from BASF SE.

In addition to the described conventional formaldehyde resins having a very high molar formaldehyde: amino group ratio, it is also possible to use formaldehyde resins having a lower molar formaldehyde: amino group ratio.

Such suitable formaldehyde resins, in particular aminoplast resins, are polycondensates of compounds having at least one amino group, including those partly substituted by organic radicals, and aldehyde, in which the molar ratio of aldehyde to amino group optionally partly substituted by organic radicals is in the range from 0.3 to 1.0, preferably from 0.3 to 0.60, particularly preferably from 0.3 to 0.45, very particularly preferably from 0.30 to 0.40.

Further suitable formaldehyde resins of this type, in particular aminoplast resins, are polycondensates of compounds having at least one amino group-NH₂ and formaldehyde, in which the molar ratio of formaldehyde to —NH₂ group is in the range from 0.3 to 1.0, preferably from 0.3 to 0.60, particularly preferably from 0.3 to 0.45, very particularly from 0.30 to 0.40.

Further suitable formaldehyde resins of this type, in particular aminoplast resins, are urea-formaldehyde resins (UF resins), melamine-formaldehyde resins (MF resins) or melamine-containing urea-formaldehyde resins (MUF resins), in which the molar ratio of formaldehyde to —NH₂ group is in the range from 0.3 to 1.0, preferably from 0.3 to 0.60, particularly preferably from 0.3 to 0.45, very particularly preferably from 0.30 to 0.40.

Further suitable formaldehyde resins of this type, in particular aminoplast resins, are urea-formaldehyde resins (UF resins), in which the molar ratio of formaldehyde to —NH₂ group is in the range from 0.3 to 1.0, preferably from 0.3 to 0.60, particularly preferably from 0.3 to 0.45, very particularly preferably from 0.30 to 0.40.

The abovementioned conventional formaldehyde resins, in particular aminoplast resins, having a lower formaldehyde content are usually used in liquid form, in general suspended in a liquid suspending medium, preferably in aqueous suspension, but can also be used as a solid.

The solids content of the formaldehyde resin suspensions, preferably aqueous suspension, is usually from 25 to 90% by weight, preferably from 50 to 70% by weight.

The solids content of an aminoplast resin as a representative of formaldehyde resins in aqueous suspension can be determined, for example, according to Günter Zeppenfeld, Dirk Grunwald, Klebstoffe in der Holz- and Möbelindustrie, 2nd edition, DRW-Verlag, page 268. For determining the solids content of aminoplast glues, 1 g of aminoplast glue is accurately weighed into a weighing dish, finely distributed on the bottom and dried for 2 hours at 120° C. in a drying oven. After thermostating at room temperature in a desiccator, the residue is weighed and is calculated as a percentage of the weight taken.

The aminoplast resins are prepared by known processes (cf. abovementioned Ullmann literature “Aminoplaste” and “Amino Resins”, and abovementioned literature Dunky et al.) by reacting compounds containing carbamido groups, preferably urea and/or melamine, with the aldehydes, preferably formaldehyde, in the desired molar carbamido group: aldehyde ratios, preferably in water as a solvent.

The desired molar ratio of aldehyde, preferably formaldehyde, to amino group optionally partly substituted by organic radicals can also be established by adding monomers carrying —NH₂ groups to prepared, preferably commercial, aminoplast resins having a relatively high formaldehyde content. Monomers carrying NH₂ groups are preferably urea and melamine, particularly preferably urea.

Another component of the binder (a) is an organic isocyanate having at least two isocyanate groups (a2).

All organic isocyanates known to the person skilled in the art, preferably those known for the production of wood-base materials or polyurethanes, can be used as suitable organic isocyanate. Such organic isocyanates and their preparation and use are described, for example in Becker/Braun, Kunststoff Handbuch, 3^{rd} revised edition, volume 7 “Polyurethane”, Hanser 1993, pages 17 to 21, pages 76 to 88 and pages 665 to 671.

Preferred organic isocyanates are oligomeric isocyanates having 2 to 10, preferably 2 to 8, monomer units and on average at least one isocyanate group per monomer unit.

A particularly preferred organic isocyanate is the oligomeric organic isocyanate PMDI (“Polymeric Methylenediphenylene diisocyanate”) which is obtainable by condensation of formaldehyde with aniline and phosgenation of the isomers and oligomers formed in the condensation (cf. for example Becker/Braun, Kunststoff Handbuch, 3^{rd} revised edition, volume 7 “Polyurethane”, Hanser 1993, page 18, last paragraph to page 19, second paragraph and page 76, fifth paragraph).

In the context of the present invention, very suitable PMDI products are the products of the LUPRANAT® series of BASF SE, in particular LUPRANAT® M 20 FB of BASF SE.

It is also possible to use mixtures of the organic isocyanates described, the mixing ratio not being critical on the basis of current knowledge.

The binder (a) may comprise the components (a1) and (a2) in all mixing ratios or alone.

In a preferred embodiment, the binder (a) comprises only the component (a1), preferably an aminoplast resin, particularly preferably a UF resin and/or MUF resin and/or MF resin.

In a further preferred embodiment, the binder (a) comprises only the component (a2), preferably PMDI.

In a further preferred embodiment, the binder (a) comprises the component (a1), preferably an aminoplast, particularly preferably a UF resin and/or MR resin and/or MUF resin, in the range from 70 to 99.9% by weight, and the component (a2), preferably PMDI, in the range from 0.1 to 30% by weight, based in each case on the sum of (a1) and (a2) of the pure undiluted substances.

In a very particularly preferred embodiment, the binder (a) comprises a UF resin in the range from 70 to 99.9% by weight and PMDI in the range from 0.1 to 30% by weight, based in each case on the sum of (a1) and (a2) of the pure, undiluted substances.

The binders (a1) and (a2) can be used in an already mixed form, but it is also possible to bring the binders (a1) and (a2), as a rule initially unmixed, into contact with the lignocellulose-containing particles, usually in separate steps.

The total amount of the binder (a1), preferably of the UF resin, as pure, undiluted substance, based on the dry mass of the lignocellulose-containing particles, preferably wood particles, is in the range from 3 to 50% by weight, preferably from 5 to 15% by weight, particularly preferably from 6 to 12% by weight.

The total amount of the binder (a2), preferably of the PMDI, as pure, undiluted substance, based on the dry mass of the lignocellulose-containing particles, preferably wood particles, is in the range from 0.5 to 30% by weight, preferably from 1 to 10% by weight, particularly preferably from 2 to 6% by weight.

Where the binder (a) is composed of (a1) and (a2), the total amount of the binder (a), as pure undiluted substance, based on the dry mass of the lignocellulose-containing particles, preferably wood particles, is in the range from 0.5 to 30% by weight, preferably from 1 to 15% by weight, particularly preferably from 2 to 12% by weight.

The binder (b) comprises:

An aqueous component (I) comprising
(i) a polymer A which is composed of the following monomers:
a) from 70 to 100% by weight of at least one ethylenically unsaturated mono- and/or dicarboxylic acid (monomer(s) A1) and
b) from 0 to 30% by weight of at least one further ethylenically unsaturated monomer which differs from the monomers A1 (monomer(s) A2)

and, optionally,
(ii) a low molecular weight crosslinker having at least two functional groups which are selected from the group consisting of hydroxyl, carboxyl and derivatives thereof, primary, secondary and tertiary amine, epoxy, aldehyde

and, optionally, a component (II) as an aqueous dispersion comprising one or more polymer(s) M, which is composed of the following monomers:
a) from 0 to 50% by weight of at least one ethylenically unsaturated monomer, which comprises at least one epoxide group and/or at least one hydroxyalkyl group (monomer(s) M1) and
b) from 50 to 100% by weight of at least one further ethylenically unsaturated monomer which differs from the monomers M1 (monomer(s) M2)

and, optionally, customary additives as component (III).

The polymer A is composed of the following monomers:
a) from 70 to 100% by weight of at least one ethylenically unsaturated mono- and/or dicarboxylic acid (monomer(s) A1) and
b) from 0 to 30% by weight of at least one further ethylenically unsaturated monomer which differs from the monomers A1 (monomer(s) A2).

The preparation of polymers A is familiar to the person skilled in the art and is effected in particular by free radical solution polymerization, for example in water or in an organic solvent (cf. for example A. Echte, Handbuch der Technischen Polymerchemie, chapter 6, VCH, Weinheim, 1993 or B. Vollmert, Grundriss der Makromolekularen Chemie, volume 1, E. Vollmert Verlag, Karlsruhe, 1988).

Suitable monomers A1 are in particular α,β-monoethylenically unsaturated mono- and dicarboxylic acids having three to six carbon atoms, the possible anhydrides thereof and the water-soluble salts thereof, in particular the alkali metal salts thereof, such as, for example, acrylic acid, methacrylic acid, maleic acid, fumaric acid, itaconic acid, citraconic acid, tetrahydrophthalic acid, or the anhydrides thereof, such as, for example, maleic anhydride, and the sodium or potassium salts of the abovementioned acids. Acrylic acid, methacrylic acid and/or maleic anhydride are particularly preferred, acrylic acid and the binary combinations of acrylic acid and maleic anhydride or acrylic acid and maleic acid being especially preferred.

Suitable monomer(s) A2 are ethylenically unsaturated compounds which can be subjected to free radical copolymerization in a simple manner with monomer(s) A1, for example ethylene; vinylaromatic monomers, such as styrene, α-methylstyrene, o-chlorostyrene, or vinyltoluenes; vinyl halides, such as vinyl chloride or vinylidene chloride; esters of vinyl alcohol and monocarboxylic acids having 1 to 18 carbon atoms, such as vinyl acetate, vinyl propionate, vinyl n-butyrate, vinyl laurate and vinyl stearate; esters of α,β-monoethylenically unsaturated mono- and dicarboxylic acids, preferably having 3 to 6 carbon atoms, such as, in particular, acrylic acid, methacrylic acid, maleic acid, fumaric acid and itaconic acid, with alkanols having in general 1 to 12, preferably 1 to 8 and in particular 1 to 4 carbon atoms, such as, in particular, methyl, ethyl, n-butyl, isobutyl, pentyl, hexyl, heptyl, octyl, nonyl, decyl and 2-ethylhexyl acrylate and methacrylate, dimethyl or di-n-butyl fumarate and maleate; nitriles of α,β-monoethylenically unsaturated carboxylic acids, such as acrylonitrile, methacrylonitrile, fumaronitrile, maleonitrile, and conjugated C₄₋₈-dienes, such as 1,3-butadiene (butadiene) and isoprene. Said monomers form as a rule the main monomers which, based on the total amount of monomers A2, together account for a proportion of ≧50% by weight, preferably ≧80% by weight and particularly preferably ≧90% by weight or even the total amount of the monomers A2. As a rule, these monomers have only moderate to low solubility in water under standard conditions of temperature and pressure (20° C., 1 atm (absolute)).

Further monomers A2, which however have a high water solubility under the abovementioned conditions, are those which comprise either at least one sulfo group and/or the corresponding anion thereof or at least one amino, amido, ureido or N-heterocyclic group and/or the ammonium derivatives thereof which are protonated or alkylated on the nitrogen. Acrylamide and methacrylamide and furthermore vinylsulfonic acid, 2-acrylamido-2-methylpropanesulfonic acid, styrenesulfonic acid and the water-soluble salts thereof and N-vinylpyrrolidone; 2-vinylpyridine, 4-vinylpyridine; 2-vinylimidazole; 2-(N,N-dimethylamino)ethyl acrylate, 2-(N,N-dimethylamino)ethyl methacrylate, 2-(N,N-diemethylamino)ethyl acrylate, 2-(N,N-diethylamino)ethyl methacrylate, 2-(N-tert.-butylamino)ethyl methacrylate, N-(3-N′,N′-dimethylaminopropyl)methacrylamide and 2-(1-imidazolin-2-onyl)ethyl methacrylate may be mentioned by way of example.

Usually, the abovementioned water-soluble monomers A2 are present only as modifying monomers in amounts ≦10% by weight, preferably ≦5% by weight and particularly preferably ≦3% by weight, based on the total amount of monomers A2.

Further monomers A2 which usually increase the internal strength of the films of a polymer matrix usually have at least one epoxy, hydroxyl, N-methylol or carbonyl group or at least two nonconjugated ethylenically unsaturated double bonds. Examples of these are monomers having two vinyl radicals, monomers having two vinylidene radicals and monomers having two alkenyl radicals. The diesters of dihydric alcohols with α,β-monoethylenically unsaturated monocarboxylic acids are particularly advantageous, among which acrylic and methacrylic acid are preferred. Examples of such monomers having two noncojugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Also of particular importance in this context are C₁-C₈-hydroxyalkyl esters of methacrylic acid and of acrylic acid, such as n-hydroxyethyl, n-hydroxypropyl or n-hydroxybutyl acrylate and methacrylate, and compounds such as diacetoneacrylamide and acetylacetoxyethyl acrylate or methacrylate.

Frequently, the abovementioned crosslinking monomers A2 are used in amounts of ≦10% by weight, but preferably in amounts of ≦5% by weight, based in each case on the total amount of monomers A2. Particularly preferably, however, no such crosslinking monomers A2 at all are used for the preparation of the polymer A.

According to the invention, the proportion of monomers A2 which is incorporated in the form of polymerized units in the polymer A is advantageously ≦10% by weight or ≦5% by weight.

Particularly advantageously, the polymer A comprises no monomers A2 at all incorporated in the form of polymerized units.

Preferred polymers A are obtainable by free radical solution polymerization of only monomers A1, particularly preferably from 65 to 100% by weight, very particularly preferably from 70 to 90% by weight, of acrylic acid with particularly preferably from 0 to 35% by weight, very particularly preferably from 10 to 30% by weight, of maleic acid or maleic anhydride.

Advantageously, polymer A has a weight average molecular weight Mw in the range from 1000 g/mol to 500000 g/mol, preferably from 10000 g/mol to 300000 g/mol, particularly preferably from 30000 g/mol to 120000 g/mol.

Establishing the weight average molecular weight Mw in the preparation of polymer A is familiar to the person skilled in the art and is advantageously effected by free radical aqueous solution polymerization in the presence of free radical chain-transfer compounds, the so-called free radical chain regulators. The determination of the weight average molecular weight Mw is also familiar to the person skilled in the art and is effected, for example, by means of gel permeation chromatography.

Suitable commercial products for polymers A are, for example, the Sokalan® products of BASF SE, which are based, for example, on acrylic acid and/or maleic acid.

Optionally, the component (I), comprises a low molecular weight crosslinker (ii) having at least two functional groups which are selected from the group consisting of hydroxyl, carboxyl and derivatives thereof, primary, secondary and tertiary amine, epoxy, aldehyde.

Suitable crosslinkers of this type are those having a molecular weight in the range from 30 to 500 g/mol. The following may be mentioned by way of example: alkanolamines, such as triethanolamine; carboxylic acids, such as citric acid, tartaric acid, butanetetracarboxylic acid; alcohols, such as glucose, glycerol, glycol; epoxides, such as bisphenol-A or bisphenol-F.

Polymer M is composed of the following monomers:
a) from 0 to 50% by weight of at least one ethylenically unsaturated monomer which comprises at least one epoxide group and/or at least one hydroxyalkyl group (monomer(s) M1) and
b) from 50 to 100% by weight of at least one further ethylenically unsaturated monomer which differs from the monomers M1 (monomer(s) M2).

Polymer M is obtainable by free radical emulsion polymerization of the corresponding monomers M1 and/or M2 in an aqueous medium. Polymer M may be present in a single-phase form or multiphase form, and can have a core/shell morphology.

The procedure for free radical emulsion polymerizations of ethylenically unsaturated monomers in an aqueous medium has been described before many times and is therefore sufficiently well known to the person skilled in the art (cf. for example: Emulsion Polymerisation in Encyclopedia of Polymer Science and Engineering, vol. 8, page 659 et seq. (1987); D. C. Blackley, in High Polymer Latices, vol. 1, page 35 et seq. (1966); H. Warson, The Applications of Synthetic Resin Emulsions, chapter 5, page 246 et seq. (1972); D. Diederich, Chemie in unserer Zeit 24, pages 135 to 142 (1990); Emulsion Polymerisation, Interscience Publishers, New York (1965); DE-A 40 03 422 and Dispersionen synthe-tischer Hochpolymerer, F. Hölscher, Springer-Verlag, Berlin (1969)).

The free radical aqueous emulsion polymerization reactions are usually effected in such a way that the ethylenically unsaturated monomers are dispersed with a concomitant use of dispersants in an aqueous medium in the form of monomer droplets and polymerized by means of a free radical polymerization initiator. Suitable monomer(s) M1 are in particular glycidyl acrylate and/or glycidyl methacrylate and hydroxyalkyl acrylates and methacrylates having C₂- to C₁₀-hydroxyalkyl groups, in particular C₂- to C₄-hydroxyalkyl groups and preferably C₂- and C₃-hydroxyalkyl groups, for example 2-hydroxyethyl acrylate, 2-hydroxyethyl methacrylate, 3-hydroxypropyl acrylate, 3-hydroxypropyl methacrylate, 4-hydroxybutyl acrylate and/or 4-hydroxybutyl methacrylate. One or more, preferably one or two, of the following monomers M1 are particularly advantageously used: 2-hydroxyethyl acrylate, 2-hydroxyethyl methacrylate, glycidyl acrylate, glycidyl methacrylate.

According to the invention, it is possible, optionally, initially to take a portion or the total amount of monomers M1 in the polymerization vessel. However, it is also possible to meter in the total amount or any remaining amount of monomers M1 during the polymerization reaction. The total amount or any remaining amount of monomers M1 can be metered into the polymerization vessel batchwise in one or more portions or continuously at constant or varying flow rates. Particularly advantageously, the metering of the monomers M1 is effected during the polymerization reaction continuously at constant flow rates, in particular as a constituent of an aqueous monomer emulsion.

Suitable monomer(s) M2 are in particular ethylenically unsaturated compounds which can undergo free radical copolymerization in a simple manner with monomer(s) M1, for example ethylene, vinylaromatic monomers, such as styrene, α-methylstyrene, o-chlorostyrene or vinyltoluenes; vinyl halides, such as vinyl chloride or vinylidine chloride; esters of vinyl alcohol and monocarboxylic acids having 1 to 18 carbon atoms, such as vinyl acetate, vinyl propionate, vinyl-n-butyrate, vinyl laurate and vinyl stearate; esters of α,β-monoethylenically unsaturated mono- and dicarboxylic acids having preferably 3 to 6 carbon atoms, such as, in particular, acrylic acid, methacrylic acid, maleic acid, fumaric acid and itaconic acid, with alkanols having in general 1 to 12, preferably 1 to 8 and in particular 1 to 4 carbon atoms, such as, in particular, methyl, ethyl, n-butyl, isobutyl, pentyl, hexyl, heptyl, octyl, nonyl, decyl and 2-ethylhexyl acrylate and methacrylate, dimethyl or di-n-butyl fumarate and maleate; nitriles of α,β-monoethylenically unsaturated carboxylic acids, such as acrylonitrile, methacrylonitrile, fumaronitrile, maleonitrile, and conjugated C₄₋₈-dienes, such as 1,3-butadiene (butadiene) and isoprene. Said monomers form as a rule the main monomers which, based on the total amount of monomers M2, together account for a proportion of ≧50% by weight, preferably ≧80% by weight and in particular ≧90% by weight. As a rule, these monomers have only moderate to low solubility in water under standard conditions of temperature and pressure (20° C., 1 atm (absolute)).

Monomers M2 which have a high water solubility under the abovementioned conditions are those which comprise either at least one acid group and/or the corresponding anion thereof or at least one amino, amido, ureido or N-heterocyclic group and/or the ammonium derivatives thereof which are protonated or alkylated on the nitrogen. α,β-Monoethylenically unsaturated mono- and dicarboxylic acids having 3 to 6 carbon atoms and the amides thereof, such as, for example, acrylic acid, methacrylic acid, maleic acid, fumaric acid, itaconic acid, acrylamide and methacrylamide, and furthermore vinylsulfonic acid, 2-acrylamido-2-methylpropanesulfonic acid, styrenesulfonic acid and the water-soluble salts thereof and N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, 2-(1-imidazolin-2-onyl)ethyl methacrylate and ureido methacrylate may be mentioned by way of example. Usually, the abovementioned water-soluble monomers M2 are present only as modifying monomers in amounts of ≦10% by weight, preferably ≦5% by weight and particularly preferably ≦3% by weight, based on the total amount of monomers M2.

Monomers M2, which usually increase the internal strength of the films of a polymer matrix, usually have at least one N-methylol or carbonyl group or at least two nonconjugated ethylenically unsaturated double bonds. Examples of these are monomers having two vinyl radicals, monomers having two vinylidene radicals and monomers having two alkenyl radicals. The diesters of dihydric alcohols with α,β-monoethylenically unsaturated monocarboxylic acids are particularly advantageous, among which acrylic and methacrylic acid are preferred. Examples of such monomers having two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Also of importance in this context are compounds such as diacetoneacrylamide and acetylacetoxyethyl acrylate or methacrylate. Frequently, the abovementioned crosslinking monomers M2 are used in amounts of ≦10% by weight, preferably in amounts of ≦5% by weight and particularly preferably in amounts of ≦3% by weight, based in each case on the total amount of monomers A2. Frequently, however, no such crosslinking monomers M2 at all are used.

According to the invention, it is possible, optionally, initially to take a portion or the total amount of monomers M2 in the polymerization vessel. However, it is also possible to meter in the total amount or any remaining amount of monomers M2 during the polymerization reaction. The total amount or any remaining amount of monomers M2 can be metered into the polymerization vessel batchwise in one or more portions or continuously at constant or varying flow rates. Particularly advantageously, the metering of the monomers M2 during the polymerization reaction is effected continuously at constant flow rates, in particular as a constituent of an aqueous monomer emulsion.

For the preparation of the aqueous dispersion of the component (II), frequently dispersants are concomitantly used which keep both the monomer droplets and the polymer particles obtained by the free radical polymerization dispersed in the aqueous phase and thus ensure the stability of the aqueous polymer composition produced. Both the protective colloids usually used for carrying out free radical aqueous emulsion polymerizations and emulsifiers are suitable as such.

Suitable protective colloids are, for example, polyvinyl alcohols, cellulose derivatives or copolymers comprising vinylpyrrolidone. A detailed description of further suitable protective colloids is to be found in Houben-Weyl, Methoden der organischen Chemie, volume XIV/1, Makromolekulare Stoffe, pages 411 to 420, Georg-Thieme-Verlag, Stuttgart, 1961.

Of course, mixtures of emulsifiers and/or protective colloids can also be used. Frequently, exclusively emulsifiers whose relative molecular weights in contrast to the protective colloids are usually below 1000 are used as dispersants. They may be anionic, cationic or nonionic. When mixtures of surface-active substances are used, the individual components must of course be compatible with one another, which in case of doubt can be checked by means of a few preliminary experiments. In general, anionic emulsifiers are compatible with one another and with nonionic emulsifiers. The same also applies to cationic emulsifiers, while anionic and cationic emulsifiers are generally not compatible with one another.

Customary emulsifiers are, for example, ethoxylated mono-, di- and trialkylphenoles (degree of EO: 3 to 50, alkyl radical: C₄ to C₁₂), ethoxylated fatty alcohols (degree of EO: 3 to 50; alkyl radical: C₈ to C₃₆) and alkali metal and ammonium salts of alkylsulfates (alkyl radical: C₈ to C₁₂), of sulfuric monoesters of ethoxylated alkanols (degree of EO: 3 to 30, alkyl radical: C₁₂ to C₁₈) and of ethoxylated alkylphenoles (degree of EO: 3 to 50, alkyl radical: C₄ to C₁₂), of alkanesulfonic acids (alkyl radical: C₁₂ to C₁₈) and of alkylarylsulfonic acids (alkyl radical: C₉ to C₁₈). Further suitable emulsifiers are to be found in Houben-Weyl, Methoden der organischen Chemie, volume XIV/1, Makromolekulare Stoffe, pages 192 to 208, Georg-Thieme-Verlag, Stuttgart, 1961.

Nonionic and/or anionic emulsifiers are preferably used for the process according to the invention.

As a rule, the amount of dispersant, in particular emulsifiers, used is from 0.1 to 5% by weight, preferably from 1 to 3% by weight, based in each case on the total amount of the monomer mixture M.

According to the invention, it is possible, optionally, initially to take a portion or the total amount of dispersant in the polymerization vessel. However, it is also possible to meter in the total amount or any remaining amount of dispersant during the polymerization reaction. The total amount or any remaining amount of dispersant can be metered into the polymerization vessel batchwise in one or more portions or continuously at constant or varying flow rates. Particularly advantageously, the metering of the dispersants during the polymerization reaction is effected continuously at constant flow rates, in particular as a constituent of an aqueous monomer emulsion.

Preferred polymers M comprise a) from 0.01 to 50% by weight of at least one ethylenically unsaturated monomer which comprises at least one epoxide group and/or at least one hydroxyalkyl group (monomer(s) M1) and b) from 50 to 99.99% by weight of at least one further ethylenically unsaturated monomer which differs from the monomers M1 (monomer(s) M2).

Particularly preferred polymers M of this type are obtainable by free radical solution polymerization of from 10 to 30% by weight, preferably from 15 to 22% by weight, of esters of acrylic acid and/or methacrylic acid with C₁₋₈-alcohols—preferably methanol, n-butanol, 2-ethylhexanol—with from 40 to 70% by weight, preferably from 55 to 65% by weight, of styrene and of from 5 to 50% by weight, preferably from 20 to 30% by weight, of 2-hydroxyethyl acrylate and/or 2-hydroxyethyl methacrylate and/or glycidyl acrylate and/or glycidyl methacrylate, the sum of the components being 100% by weight.

Further preferred polymers M comprise no monomers) M1 and are obtainable by free radical solution polymerization of from 80 to 99% by weight, preferably from 85 to 95% by weight, of esters of acrylic acid and/or methacrylic acid with C₁₋₈-alcohols—preferably methanol, n-butanol, 2-ethylhexanol—with from 0 to 5% by weight, preferably from 1 to 3% by weight, of ureido methacrylate and of from 0.5 to 5% by weight, preferably from 1 to 4% by weight, of α,β-monoethylenically unsaturated mono- and dicarboxylic acids having 3 to 6 carbon atoms—preferably acrylic acid, methacrylic acid—and/or amides of these acids, the sum of the components being 100% by weight.

Such polymers preferably have a core/shell morphology (isotropic distribution of the phases, for example in the form of onion skins) or a Janus morphology (anisotropic distribution of the phases).

By targeted variation of type and amount of monomers M1 and M2, it is possible for the person skilled in the art, according to the invention, to prepare aqueous polymer compositions whose polymers M have a glass transition temperature T_{g} or a melting point in the range from −60 to 270° C.

Advantageously, the glass transition temperature T_{g} of the polymer M is in the range from 10° C. to 120° C. and preferably in the range from 30° C. to 90° C.

The glass transition temperature T_{g}, is understood as meaning the limit of the glass transition temperature toward which the glass transition temperature tends with increasing molecular weight, according to G. Kanig (Kolloid-Zeitschrift & Zeitschrift für Polymere, vol. 190, page. 1, equation 1). The glass transition temperature or the melting point is determined by the DSC method (Differential Scanning Calorimetry, 20 K/min, midpoint measurement, DIN 53765).

The T_{g} values for the homopolymers of most monomers are known and are listed, for example, in Ullmann's Encyclopedia of Industrial Chemistry, part 5, vol. A21, page 169, VCH Weinheim, 1992; further sources of glass transition temperatures of homopolymers are, for example, J. Brandrup, E. H. Immergut, Polymer Handbook, 1^{st} Ed., J. Wiley, New York 1966, 2^{nd} Ed. J.Wiley, New York 1975, and 3^{rd} Ed, J. Wiley, New York 1989).

The components (I) and (II) according to the invention usually have polymer solids contents (total amount of polymer A or total amount of polymer M) of ≧10 and ≦70% by weight, frequently ≧20 and ≦65% by weight and often ≧40 and ≦60% by weight, based on the respective aqueous component (I) or (II).

The number average particle diameter (cumulant z average) of the polymer M, determined via quasielastic light scattering (ISO standard 13321), in the aqueous component (II) is as a rule from 10 to 2000 nm, frequently from 20 to 1000 nm and often from 50 to 700 nm or from 80 to 400 nm.

The weight ratio of polymer A to polymer M is in the range from 1:10 to 10:1, preferably in the range from 3:1 to 1:3, particularly preferably in the range from 3:2 to 2:3. The stated weights are based in each case on the pure, undiluted substances or on the solid.

The pH of the binder (b) is in the range from 0 to 4, preferably in the range from 1.5 to 3. The desired pH of the binder B arises as a rule by the combination of the components (I) and (II) and, optionally, component (III).

The pH of the binder (b) at the place of action can, however, be adjusted to the desired value in the range from 0 to 4, preferably in the range from 1.5 to 3, in a customary manner by addition of inorganic or organic acids, for example mineral acids, such as sulfuric acid or hydrochloric acid, organic sulfonic acids, carboxylic acids, such as formic acid or acetic acid, or inorganic or organic bases, for example sodium hydroxide (aqueous or as such), calcium oxide or calcium carbonate (in each case aqueous or as such) or ammonia, aqueous or as such.

In general, the ready-mixed binder (b) having the abovementioned pH ranges can be used. The desired pH—as described above—can, however, also be adjusted by applying the individual components of the binder (b) and the acids or bases described above separately to the lignocellulose-containing substrate. Through the choice of the pH of the components of the binder (b) and of the added acids or bases, the person skilled in the art can combine them so that the desired pH is established on the lignocellulose-containing substrate.

The term additive as component (III) is to be understood as meaning all additives known to the person skilled in the art, for example waxes, paraffin emulsion, flame-retardant additives, wetting agents, salts, but also inorganic or organic acids and bases, for example mineral acids, such as sulfuric acid or nitric acid, organic sulfonic acids, carboxylic acids, such as formic acid or acetic acid, or inorganic or organic bases, for example sodium hydroxide (aqueous or as such), calcium oxide or calcium carbonate (in each case aqueous or as such) or ammonia, aqueous or as such. These additives can be added in an amount of from 0 to 20% by weight, preferably from 0 to 5% by weight, in particular from 0 to 1% by weight, based on the dry mass of the lignocellulose-containing particles, for example absolutely dry wood.

The lignocellulose-containing particles, preferably wood particles, particularly preferably wood chips or fibers, are coated with glue as a rule by bringing into contact with the binder (a) or (b). So-called glue application methods of this type are known for the production of conventional wood-base materials with customary aminoplast resins and are described, for example, in “Taschenbuch der Spanplatten Technik”, H.-J. Deppe, K. Ernst, 4th edition, 2000, DRW-Verlag Weinbrenner GmbH & Co., Leinfelden-Echter-dingen, chapter 3.3.

The binder (a) or (b) can be brought into contact with the lignocellulose-containing particles, preferably wood particles, particularly wood chips or fibers, in various ways, preferably by spraying (a) or (b) onto the lignocellulose-containing particles.

In the glue application, the binder (a) or (b) is usually used in an amount such that, based on the dry mass of the lignocellulose-containing particles, for example absolutely dry wood, from 0.1 to 50% by weight, preferably from 0.1 to 30% by weight, particularly preferably from 0.5 to 15% by weight and in particular from 3 to 10% by weight of binder, based on the pure, undiluted binder, are used.

If the binder (a) comprises a formaldehyde resin as described above, the binder (b) comprises a formaldehyde scavenger.

This means chemical substances which as a rule have a free electron pair which reacts chemically with the formaldehyde, i.e. chemically binds the formaldehyde, as a rule virtually irreversibly. Such free electron pairs are present, for example, on the following functional groups of organic or inorganic compounds: primary, secondary and tertiary amino groups, hydroxyl group, sulfite group, amides, imides.

Examples of suitable formaldehyde scavengers are: ammonia, urea, melamine, organic C₁-C₁₀-amines, polymers which carry at least one amino group, such as polyamines, polyimines, polyureas, polylysines, polyvinylamine, polyethylenimine.

The proportion of the formaldehyde scavengers in the binder (b) is in the range from 0.1 to 10% by weight, preferably from 0.5 to 7% by weight, based on the dry mass of the lignocellulose-containing particles, for example absolutely dry wood, and pure, undiluted formaldehyde scavenger.

The multilayer lignocellulose-containing moldings may have a regular or irregular three-dimensional shape. The following are examples of suitable desired shapes: all regular moldings, such as spheres, cylinders, cuboids, boards; all irregular shapes, such as irregular cavities, ornaments.

Preferred desired shapes are sheet-like, the form of a board being particularly preferred.

Further preferred multilayer lignocellulose-containing moldings comprise more than 90% by weight of wood particles as lignocellulose-containing particles.

Further preferred multilayer lignocellulose-containing moldings comprise more than 90% by weight of wood fibers or wood chips as lignocellulose-containing particles.

The average density of the multilayer lignocellulose-containing moldings is usually in the range from 300 kg/m³ to 950 kg/m³, preferably from 450 kg/m³ to 850 kg/m³.

The multilayer lignocellulose-containing moldings according to the invention have a middle layer or a plurality of middle layers A) comprising lignocellulose-containing particles and a binder (a) and a covering layer or two covering layers (B) comprising lignocellulose-containing particles and a binder (b).

In the context of the invention, middle layer or middle layers is or are all layers which are not the outer layers.

The outer layer or the outer layers of the multilayer lignocellulose-containing moldings according to the invention are also referred to here as covering layer or covering layers.

Preferred multilayer lignocellulose-containing moldings according to the invention are sheet-like, preferably in the form of a board, comprising wood particles, particularly preferably wood chips or wood fibers, as lignocellulose-containing particles, and have three layers; a middle layer A) and one covering layer B) each on the top and bottom thereof.

For the production of the multilayer lignocellulose-containing moldings, for example of the abovementioned, three-layer lignocellulose-containing moldings, the following binders are preferably used for the respective layers:

In a particularly suitable embodiment, the binder (b) comprises no low molecular weight crosslinker (ii) but does comprise a component (II), as described, for example, under variant 1, variant 2 and variant 3 below.

Variant 1:

For the middle layer A) or the middle layers A), the binder (a) comprises only the component (a1), preferably an aminoplast resin, particularly preferably a UF resin and/or MUF resin.

For a covering layer B) or the two covering layers B), the binder (b) is used; for example, the binder (b) comprises an aqueous solution of a polymer A according to the invention, obtainable by free radical solution polymerization of 70% by weight of acrylic acid and 30% by weight of maleic anhydride in water. The component (I) comprises no further crosslinking component. The component (II) of the binder (b) is an aqueous dispersion of a polymer M according to the invention, obtainable by free radical emulsion polymerization of from 50 to 65% by weight of styrene and from 5 to 15% by weight of methyl methacrylate, from 5 to 15% by weight of n-butyl acrylate, from 10 to 30% by weight of hydroxyethyl acrylate and from 2 to 20% by weight of glycidyl methacrylate in water, the sum of the monomers being 100% by weight.

The binder (b) furthermore comprises a formaldehyde scavenger as defined above, in the amounts as defined there.

Variant 2:

For the middle layer A) or the middle layers A), the binder (a) comprises the component (a1), preferably an aminoplast, particularly preferably a UF resin and/or MUF resin, and the component (a2), preferably PMDI, in the amounts defined above for the combination (a1) and (a2).

For a covering layer B) or the two covering layers B), the binder (b) is used; for example, the binder (b) comprises an aqueous solution of a polymer A according to the invention, obtainable by free radical solution polymerization of 70% by weight of acrylic acid and 30% by weight of maleic anhydride in water. The component (I) comprises no further crosslinking component. The component (II) of the binder (b) is an aqueous dispersion of a polymer M according to the invention, obtainable by free radical emulsion polymerization of from 50 to 65% by weight of styrene and from 5 to 15% by weight of methyl methacrylate, from 5 to 15% by weight of n-butyl acrylate, from 10 to 30% by weight of hydroxyethyl acrylate and from 2 to 20% by weight of glycidyl methacrylate in water, the sum of the monomers being 100% by weight.

The binder (b) furthermore comprises a formaldehyde scavenger as defined above, in the amounts as defined there.

Variant 3:

For the middle layer A) or the middle layers A), the binder (a) comprises only the component (a2), preferably PMDI.

For a covering layer B) or the two covering layers B), the binder (b) is used; for example, the binder (b) comprises an aqueous solution of a polymer A according to the invention, obtainable by free radical solution polymerization of 70% by weight of acrylic acid and 30% by weight of maleic anhydride in water. The component (I) comprises no further crosslinking component. The component (II) of the binder (b) is an aqueous dispersion of a polymer M according to the invention, obtainable by free radical emulsion polymerization of from 50 to 65% by weight of styrene and from 5 to 15% by weight of methyl methacrylate, from 5 to 15% by weight of n-butyl acrylate, from 10 to 30% by weight of hydroxyethyl acrylate and from 2 to 20% by weight of glycidyl methacrylate in water, the sum of the monomers being 100% by weight.

In a further very suitable embodiment, the binder (b) comprises a low molecular weight crosslinker (ii) and no component (II), as described by way of example below under variant 4 and variant 5.

Variant 4:

For the middle layer A) or the middle layers A), the binder (a) comprises only the component (a1), preferably an aminoplast resin, particularly preferably a UF resin and/or MUF resin.

For a covering layer B) or the two covering layers B), the binder (b) is used; for example, the binder (b) comprises an aqueous solution of a polymer A according to the invention, obtainable by free radical solution polymerization of 70% by weight of acrylic acid and 30% by weight of maleic anhydride in water. The component (I) comprises additionally a crosslinker component (ii), preferably having more than two functional groups per crosslinker molecule, particularly preferably triethanolamine.

The binder (b) further comprises a formaldehyde scavenger as defined above, in the amounts as defined there.

Variant 5:

For the middle layer A) or the middle layers A), the binder (a) comprises only the component (a2), preferably PMDI.

For a covering layer B) or the two covering layers B), the binder (b) is used; for example, the binder (b) comprises an aqueous solution of a polymer A according to the invention, obtainable by free radical solution polymerization of 70% by weight of acrylic acid and 30% by weight of maleic anhydride in water. The component (I) comprises additionally a crosslinker component (ii), preferably having more than two functional groups per crosslinker molecule, particularly preferably triethanolamine.

In a further highly suitable embodiment, the binder (b) comprises both a low molecular weight crosslinker (ii) and a component (II), as described by way of example below under variant 6.

Variant 6:

For the middle layer A) or the middle layers A), the binder (a) comprises for the component (a1), preferably an aminoplast, particularly preferably a UF resin and/or MUF resin, and/or the component (a2), preferably PMDI, in the amounts defined above for the combination (a1) and (a2).

For a covering layer B) or the two covering layers B), the binder (b) is used; for example, the binder (b) comprises an aqueous solution of a polymer A according to the invention, obtainable by free radical solution polymerization of 70% by weight of acrylic acid and 30% by weight of maleic anhydride in water. The component (I) additionally comprises a crosslinker component (ii), preferably with more than two functional groups per crosslinker molecule, particularly preferably triethanolamine. The component (II) of the binder (b) is an aqueous dispersion of a polymer M according to the invention, obtainable by free radical emulsion polymerization of from 50 to 65% by weight of styrene and from 5 to 15% by weight of methyl methacrylate, from 5 to 15% by weight of n-butyl acrylate, from 10 to 30% by weight of hydroxyethyl acrylate and from 2 to 20% by weight of glycidyl methacrylate in water, the sum of the monomers being 100% by weight.

The binder (b) further comprises a formaldehyde scavenger as defined above, in the amounts as defined there.

The thickness of the multilayer lignocellulose-containing moldings according to the invention, preferably of the board-like moldings, varies with the field of use and is as a rule in the range from 0.5 to 300 mm, preferably in the range from 10 to 200 mm, in particular from 12 to 100 mm.

The thickness ratios of the layers of the multilayer lignocellulose-containing moldings according to the invention, preferably of the board-like moldings, are variable. Usually, the outer layers A), also referred to as covering layers, by themselves or in total, are thinner than the layer or layers of the middle layer(s) B).

The mass of the individual covering layer is usually in the range from 5 to 30% by weight, preferably from 10 to 25% by weight, of the total mass of the multilayer lignocellulose-containing molding according to the invention.

In the preferred multilayer lignocellulose-containing molding according to the invention, preferably the board-like molding, the thickness of the middle layer(s) B), based on the total thickness of the multilayer lignocellulose-containing molding according to the invention, preferably the board-like molding, is in the range from 20% to 99%, preferably from 50% to 99%, particularly preferably from 60% to 99%.

The multilayer lignocellulose-containing moldings according to the invention, preferably those in which the lignocellulose-containing particles are wood particles, particularly preferably wood chips or wood fibers, are produced in the customary manner, as described in “Taschenbuch der Spanplatten Technik” H.-J. Deppe, K. Ernst, 4^{th} edition, 2000, DRW-Verlag Weinbrenner GmbH & Co., Leinfelden-Echterdingen, chapter 3.5.

Usually, first lignocellulose-containing particles, for the middle layer(s) A) and the covering layer(s) B), preferably wood, for example in the form of fibers, chips, veneers or strands, as described above, are brought into contact (also referred to as “glue-coated”) with the respective binder (a) (for the middle layer(s) A)) or (b) (for the covering layer(s) B)).

Thereafter, the lignocellulose-containing particles, preferably wood, for example in the form of fibers, chips, veneers or strands, glue-coated in this manner are placed in layers one on top of the other according to the desired sequence of the multilayer lignocellulose-containing molding to be produced and are pressed at elevated temperature by a customary method to give multilayer lignocellulose-containing moldings, preferably those in which the lignocellulose-containing particles are wood, for example in the form of fibers, chips, veneers or strands.

For this purpose, a fiber/chip mat is usually produced by sprinkling the lignocellulose-containing particles glue-coated in this manner—preferably wood, particularly preferably wood in the form of chips or fibers—onto a substrate and said mat is usually pressed at temperatures of from 80° C. to 250° C. and at pressures of from 5 to 50 bar to give multilayer lignocellulose-containing moldings according to the invention (cf. for example: “Taschenbuch der Spanplatten Technik” H.-J. Deppe, K. Ernst, 4^{th} edition, 2000, DRW-Verlag Weinbrenner GmbH & Co., Leinfelden-Echterdingen, pages 232-254. “MDF-Mitteldichte Faserplatten” H.-J. Deppe, K. Ernst, 1996, DRW-Verlag Weinbrenner GmbH & Co., Leinfelden-Echterdingen, pages 93-104).

The pressing times required for board manufacture are typically given as “seconds per mm board thickness” or s/mm (and often also referred to as pressing time factor). For multilayer lignocellulosic moldings of the invention, the pressing time factors generally required are those of the kind known for the quick formaldehyde resins: on a Siempelkamp laboratory press (dimensions 520*520*mm²), for moldings according to the invention, pressing time factors required are generally from 8 to 10 s/mm, as they are also for boards manufactured only with aminoplast-containing binders; moldings manufactured with formaldehyde-free binders, for example products of the Acrodur® product range from BASF SE, require pressing time factors of more than 25 s/mm.

Particularly preferred multilayer lignocellulose-containing moldings according to the invention are all those which are produced from wood strips, for example veneer sheets or plywood sheets, or multilayer lignocellulose-containing moldings produced from wood chips, for example particle boards or OSB boards, and multilayer wood fiber materials, such as LDF, MDF and HDF boards.

Wood-base materials comprising formaldehyde-free binders are advantageously produced by the process according to the invention. Multilayer OSB boards, wood fiber boards and particle boards are preferred.

The present invention furthermore relates to the use of the multilayer lignocellulose-containing moldings according to the invention, preferably the multilayer wood-containing moldings according to the invention, for the production of pieces of furniture, of packaging materials, in house building, in drywall construction or in interior finishing, for example as laminate, insulating material, wall or ceiling element, or in motor vehicles.

In comparison with multilayer lignocellulose-containing moldings not according to the invention and comprising formaldehyde resin in all layers, the multilayer lignocellulose-containing moldings according to the invention show a greatly reduced emission of formaldehyde or virtually no emission of formaldehyde.

The formaldehyde emissions were measured, for example, by the following methods according to testing procedures for wood-base materials (Bundesgesetzblatt 10/91, pages 488/489): CEN prEN 717-1 (“Desiccator”); DIN EN 120 (“Perforator value”); DIN 52368 (corresponding to CEN prEN 717-2; gas analysis or cubic meter chamber value).

The multilayer lignocellulose-containing moldings according to the invention moreover show increased peel strength for the covering layers, also in comparison with multilayer lignocellulose-containing moldings not according to the invention and comprising formaldehyde resin in all layers.

### EXAMPLES

1. Components (I) and (II)

The component (I) was a commercially available aqueous solution of a polymer A according to the invention, obtainable by free radical solution polymerization of 70% by weight of acrylic acid and 30% by weight of maleic anhydride in water. The component (I) comprised no further crosslinking component, such as polyalkanolamines, for example triethanolamine. The weight average molecular weight Mw was 80 000 g/mol. The solids content was 45% by weight.

The component (II) was a commercially available aqueous dispersion of a polymer M according to the invention, obtainable by free radical emulsion polymerization of 59% by weight of styrene and 12% by weight of methyl methacrylate, 5% by weight of n-butyl acrylate, 16% by weight of hydroxyethyl acrylate and 8% by weight of glycidyl methacrylate in water.

The particle size was on average 140 nm. The pH was 1.9. The solids content was 46% by weight.

2. List of the Binder Compositions Used

BM1: Components (I) and (II) described under 1. in a 1:1 mixture (based on the respective solids content).

BM2: 9% of absolutely dry UF glue, in this case KAURIT® KL 347 of BASF SE plus 4% by weight (based on the solids content of the glue) of ammonium nitrate curing agent.

BM3: 9% of absolutely dry UF glue, in this case KAURIT® KL 347 of BASF SE plus 1% by weight (based on the solids content of the glue) of ammonium nitrate curing agent.

BM4: Component (I) described under 1., but with triethanolamine (30 parts per 100 parts of (I)) as crosslinker (ii).

BM5: Lupranat® M20 FB, an isocyanate-based binder from BASF SE.

BM6: A mixture of 100 parts by weight of BM1 and 10 parts by weight of triethanolamine.

3. Methods of Measurements and Results of Measurements

The determination of the formaldehyde emission was effected by the following methods according to testing procedures for wood-base materials (Bundesgesetzblatt 10/91, pages 488/489): CEN prEN 717-1 (“Desiccator”); DIN EN 120 (“Perforator value”); DIN 52368 (corresponding to CEN prEN 717-2, gas analysis or cubic meter chamber value).

The methods for the testing of the moldings manufactured in this way are as follows: lifting resistance (LR): EN311; flexural strength (FS) EN310; transverse tensile strength (TTS) EN319; density EN323; moisture content EN322; thickness swelling (D24h) EN317

Quantity figures in the examples are often given as “% O.D.”; these figures, as a percentage by weight, then always relate to the amount of the solid in the wood (O.D.=oven dry). The wood used always corresponds to 100% O.D. (see also Deppe and Ernst 2000, p. 32)

The results are listed in Table 2.

4. Production and Testing of the Multilayer Lignocellulose-Containing Moldings

4.1 Production

The amount of spruce chips stated in Table 1 (conditioned at 20° C., 65% relative humidity) was glue-coated with the corresponding amount of aqueous binder (cf. Table 1, column headed Solids content of binder; the amounts of solid of the binder, based on absolutely dry wood, are stated) in a Lodige mixer and the moisture content was measured. Thereafter, the mats for the middle layer and the covering layers were sprinkled and were pressed at 200° C. with a pressing time factor of 10 s/mm board thickness.

The three-layer lignocellulose-containing moldings produced in the experiments were tested for the properties stated under 3. using the methods stated there.

The results of these tests are shown in Table 2.

The experiments and results show that the multilayer, lignocellulose-containing moldings according to the invention have a formaldehyde emission reduced up to 10 times, depending on the method of measurement (cubic meter chamber value method; the closest to the end product for furniture applications)—see, for example, series A.

Series A shows the direct comparison of the conventional reference board (cover layer and middle layer with UF resin) with a board according to the invention. The mechanical properties are comparable; the lifting resistance of the board 1 according to the invention (column #) is, however, higher than that of the reference board. The formaldehyde emissions of the board 1 according to the invention are significantly reduced.

Series B shows the relationship between the formaldehyde emission and the type of binder in the cover layer (boards 1, 4, and 5), and also the influence of the amount of urea in the cover layer (boards 1, 2, and 3).

The urea in the cover layer leads significantly to a surprisingly better lifting resistance (adhesion of the cover layer to the middle layer).

Both effects, namely formaldehyde reduction and improvement in lifting resistance, already shown in series A and B, are confirmed once again in series C, now with the corresponding cubic meter chamber values (see series C, boards 1 to 3), and the comparison of board 4 in series B with board 4 in series C also shows that urea leads to a surprisingly better lifting resistance.

Series D uses a different, specifically formaldehyde-free, middle-layer binder from the preceding series (see preferred variant 5). In the case of the manufacture of board 1, no release agent was needed between cover layer surface (board surface) and metal pressing plate, which otherwise, in the case of isocyanate-containing binders prevents sticking to the metal pressing plate.

Series E shows that it is not possible to manufacture a chipboard with low pressing time factors solely with a formaldehyde-free binder (b), which is used in the cover layer in this invention. Only with pressing time factors that are twice as high (that is 25 s/mm onward), in comparison to the pressing time factors according to the invention, is a stable board obtained.

TABLE 1
Production parameters

| | | | | | Extra | Pressing | Layer | | Mass | Solids content | Chip |
|---|---|---|---|---|---|---|---|---|---|---|---|
| | | | | Gluing | urea | time factor | thickness | Density | of wood | of binder | moisture |
| Series | # | Binder | Layer | O.D. | O.D. | s/mm | mm | kg/m³ | g | g | O.D. |
| A | Ref | BM3 | CL | 9.00% | | 10 | 6.4 | 650 | 1125 | 101 | 6.90% |
| | | BM2 | ML | 9.00% | | | 9.6 | | 1687 | 152 | 6.00% |
| | 1 | BM1 | CL | 6.00% | 5.00% | | 6.4 | | 1125 | 67 | 10.20% |
| | | BM2 | ML | 9.00% | | | 9.6 | | 1687 | 152 | 6.70% |
| B | Ref | BM3 | CL | 9.0% | | | 6.4 | | 1125 | 101 | 6.9% |
| | | BM2 | ML | 9.0% | | | 9.6 | | 1687 | 152 | 6.0% |
| | 1 | BM1 | CL | 6.0% | 5.0% | | 6.4 | | 1125 | 68 | 10.2% |
| | | BM2 | ML | 9.0% | | | 9.6 | | 1687 | 152 | 6.0% |
| | 2 | BM1 | CL | 6.0% | 3.0% | | 6.4 | | 1125 | 68 | 7.3% |
| | | BM2 | ML | 9.0% | | | 9.6 | | 1687 | 152 | 6.0% |
| | 3 | BM1 | CL | 6.0% | 1.0% | | 6.4 | | 1125 | 68 | 9.8% |
| | | BM2 | ML | 9.0% | | | 9.6 | | 1687 | 152 | 6.0% |
| | 4 | BM4 | CL | 6.0% | 5.0% | | 6.4 | | 1125 | 68 | 7.7% |
| | | BM2 | ML | 9.0% | | | 9.6 | | 1687 | 152 | 5.7% |
| | 5 | BM6 | CL | 6.0% | 5.0% | | 6.4 | | 1125 | 68 | 7.7% |
| | | BM2 | ML | 9.0% | | | 9.6 | | 1687 | 152 | 5.7% |
| C | Ref | BM3 | CL | 9.0% | | | 6.4 | | 1125 | 101 | 6.9% |
| | | BM2 | ML | 9.0% | | | 9.6 | | 1687 | 152 | 6.0% |
| | 1 | BM1 | CL | 6.0% | | | 6.4 | | 1125 | 68 | 8.8% |
| | | BM2 | ML | 9.0% | | | 9.6 | | 1687 | 152 | 7.1% |
| | 2 | BM1 | CL | 6.0% | 1.0% | | 6.4 | | 1125 | 68 | 9.0% |
| | | BM2 | ML | 9.0% | | | 9.6 | | 1687 | 152 | 6.1% |
| | 3 | BM1 | CL | 6.0% | 5.0% | | 6.4 | | 1125 | 68 | 9.4% |
| | | BM2 | ML | 9.0% | | | 9.6 | | 1687 | 152 | 7.0% |
| | 4 | BM4 | CL | 6.0% | | | 6.4 | | 1125 | 68 | 7.8% |
| | | BM2 | ML | 9.0% | | | 9.6 | | 1687 | 152 | 7.1% |
| D | Ref | BM5 | CL | 3.2% | | 14 | 6.4 | 680 | 1125 | 36 | |
| | | BM5 | ML | 3.5% | | | 9.6 | | 1687 | 59 | |
| | 1 | BM4 | CL | 6.0% | | | 6.4 | | 1125 | 68 | |
| | | BM5 | ML | 3.5% | | | 9.6 | | 1687 | 59 | |
| E | Ref | BM6 | CL | 6% | | | 6.4 | | 1125 | 68 | |
| | | BM6 | ML | 6% | | | 9.6 | | 1687 | 101 | |

Abbreviations used:
CL: Cover layers; ML: Middle layer
#: Designation/number of the board

TABLE 2
Measured values

| | | | | | Mechanical properties | | Formaldehyde emission | | |
|---|---|---|---|---|---|---|---|---|---|
| | | Cover layer | | Middle | Transverse | Lifting | Perforator | | m³ |
| | | | Extra urea | layer | tensile strength | resistance | mg/100 g | Desiccator | chamber |
| Series | # | Binder | O.D. | Binder | N/mm² | N/mm² | O.D. | mg/l | ppm |
| A | Ref | BM3 | — | BM2 | 0.80 | 0.80 | 4.9 | 1.08 | 0.122 |
| | 1 | BM1 | 5% | BM2 | 0.78 | 1.10 | 1.6 | 0.35 | 0.012 |
| B | Ref | BM3 | — | BM2 | 0.89 | 1.55 | 5.2 | 1.25 | — |
| | 1 | BM1 | 5% | BM2 | 0.76 | 1.27 | 1.5 | 0.32 | — |
| | 2 | BM1 | 3% | BM2 | 0.85 | 1.23 | 2.2 | 0.55 | — |
| | 3 | BM1 | 1% | BM2 | 0.82 | 1.08 | 3.5 | 0.82 | — |
| | 4 | BM4 | 5% | BM2 | 0.86 | 1.35 | 1.1 | 0.30 | — |
| | 5 | BM6 | 5% | BM2 | 0.93 | 1.50 | 1.0 | 0.28 | — |
| C | Ref | BM3 | — | BM2 | 0.66 | 0.80 | 4.9 | 1.08 | 0.122 |
| | 1 | BM1 | — | BM2 | 0.52 | 0.56 | 4.9 | 1.15 | 0.165 |
| | 2 | BM1 | 1% | BM2 | 0.83 | 0.72 | 3.6 | 0.79 | 0.101 |
| | 3 | BM1 | 5% | BM2 | 0.78 | 1.06 | 1.6 | 0.35 | 0.012 |
| | 4 | BM4 | — | BM2 | 0.36 | 0.38 | 4.8 | 1.05 | 0.150 |
| D | Ref | BM5 | — | BM5 | 0.95 | 1.70 | — | — | — |
| | 1 | BM4 | — | BM5 | 0.75 | 1.60 | — | — | — |
| E | Ref | BM6 | — | BM6 | * | * | * | * | * |

* It was not possible to manufacture a board under the pressing conditions indicated. Only with a pressing time factor twice as high were stable boards obtained.
#: Designation/number of the board

1.-12. (canceled)

13. A multilayer lignocellulose-containing molding comprising
A) a middle layer or a plurality of middle layers comprising lignocellulose-containing particles which is/are obtainable by using a binder (a) and
B) a covering layer or a plurality of covering layers comprising lignocellulose-containing particles which is/are obtainable by using a binder (b),
the binder (a) being selected from the group consisting of (a1) formaldehyde resins and (a2) an organic isocyanate having at least two isocyanate groups;
the binder (b) comprising the following components:
an aqueous component (I) comprising
(i) a polymer A which is composed of the following monomers:
a) from 70 to 100% by weight of at least one ethylenically unsaturated mono- and/or dicarboxylic acid (monomer(s) A1) and
b) from 0 to 30% by weight of at least one further ethylenically unsaturated monomer which differs from the monomers A1 (monomer(s) A2)
and, optionally,
(ii) a low molecular weight crosslinker having at least two functional groups which are selected from the group consisting of hydroxyl, carboxyl and derivatives thereof, primary, secondary and tertiary amine, epoxy, aldehyde
and, optionally, a component (II), as an aqueous dispersion, comprising one or more polymer(s) M which is composed of the following monomers:
a) from 0 to 50% by weight of at least one ethylenically unsaturated monomer which comprises at least one epoxide and/or at least one hydroxyalkyl group (monomer(s) M1) and
b) from 50 to 100% by weight of at least one further ethylenically unsaturated monomer which differs from the monomers M1 (monomer(s) M2)
and, optionally, additional additives as component (III),
and, where the binder (a) comprises a formaldehyde resin, the binder (b) comprising formaldehyde scavengers.

14. The multilayer lignocellulose-containing molding according to claim 13, wherein the binder (b) comprises a low molecular weight crosslinker ((ii) and no component (II).

15. The multilayer lignocellulose-containing molding according to claim 13, wherein the binder (b) comprises no low molecular weight crosslinker (ii), but comprises a component (II).

16. The multilayer lignocellulose-containing molding according to claim 13, wherein the binder (b) comprises both a low molecular weight crosslinker (ii) and a component (II).

17. The multilayer lignocellulose-containing molding according to claim 13, which is in the form of three layers, comprising a middle layer A) and two covering layers B).

18. The multilayer lignocellulose-containing molding according to claim 13, wherein the binder (a) is only a formaldehyde resin (a1).

19. The multilayer lignocellulose-containing molding according to claim 13, wherein the binder (a) is only an organic isocyanate having at least two isocyanate groups (a1).

20. The multilayer lignocellulose-containing molding according to claim 13, wherein the binder (a) comprises the component (a1) in the range from 70 to 99.9% by weight and the component (a2) in the range from 0.1 to 30% by weight, based in each case on the sum of (a1) and (a2) of the pure undiluted substances.

21. The multilayer lignocellulose-containing molding according to claim 13, in the form of a board.

22. A process for the production of the multilayer lignocellulose-containing molding according to claim 13, which comprises bringing the lignocellulose particles for the middle layer or the middle layers (A) into contact with the binder (a), bringing the lignocellulose particles for the covering layer or the covering layers (B) into contact with the binder (b), arranging them in layers one on top of the other according to the desired sequence and pressing them at elevated temperature.

23. A process for the production of articles which comprises utilizing the multilayer lignocellulose-containing molding according to claim 13.

24. An article which comprises the multilayer lignocellulose-containing molding according to claim 13.

25. A process for production of pieces of furniture, furniture parts, of packaging materials, in house building or in interior finishing or in motor vehicles which comprises utilizing the multilayer lignocellulose-containing molding according to claim 13.

26. A piece of furniture, furniture part, packaging material, in house building or in interior finishing or in motor vehicles which comprises the multilayer lignocellulose-containing molding according to claim 13
